(19) United States
(12) Patent Application Publication
(10) Pub. No.: US 2026/0303931 A1
(43) Pub. Date: Oct. 1, 2026

(54) METHOD, APPARATUS, DEVICE AND STORAGE MEDIUM FOR VIDEO GENERATION

(71) Applicants: Bytedance Technology Ltd., Grand Cayman (KY); Beijing Zitiao Network Technology Co., Ltd., Beijing (CN)

(72) Inventors: Qi ZHAO, Los Angeles, CA (US); Xingyu NI, Beijing (CN); Ziyu WANG, Beijing (CN); Feng CHENG, Los Angeles, CA (US); Ziyan YANG, Los Angeles, CA (US); Lu JIANG, Los Angeles, CA (US); Bohan WANG, Los Angeles, CA (US)

(21) Appl. No.: 19/629,913

(22) Filed: Mar. 26, 2026

(30) Foreign Application Priority Data
Mar. 26, 2025 (CN) 202510368332.3

(51) Int. Cl. H04N 21/81; H04N 21/84

(52) U.S. Cl. CPC H04N 21/816; H04N 21/84

(57) ABSTRACT

Embodiments of the disclosure relate to a method, an apparatus, a device, and a computer-readable storage medium for generating video. The method proposed herein includes: receiving a video generation request; and processing the video generation request by a video generation model to generate video content, where the video generation model is trained based on a synthetic dataset, and the synthetic dataset is generated based on a process including: generating, by a scene generation module, a synthetic video associated with a virtual three-dimensional object; generating, by a video description module, description text corresponding to the synthetic video; and constructing a synthetic data sample in the synthetic dataset based on the synthetic video and the description text.

### CROSS-REFERENCE

The present application claims priority to Chinese Patent Application No. 202510368332.3, filed on Mar. 26, 2025, and entitled “METHOD, APPARATUS, DEVICE AND STORAGE MEDIUM FOR VIDEO GENERATION”, which is incorporated herein by reference in its entirety.

### FIELD

Example embodiments of the present disclosure generally relate to the field of computers, and in particular, to a method, an apparatus, a device, and a computer-readable storage medium for video generation.

### BACKGROUND

With the development of computer technologies, generative models are gradually applied to processing various tasks. For example, some generative models are capable of generating video content based on input prompt information. However, the video content generated by some generative models has poor realism, for example, does not conform to physical laws.

### SUMMARY

In a first aspect of the present disclosure, a method for video generation is provided. The method includes: receiving a video generation request; and processing the video generation request by a video generation model to generate video content, where the video generation model is trained based on a synthetic dataset, and the synthetic dataset is generated based on a process including: generating, by a scene generation module, a synthetic video associated with a virtual three-dimensional object; generating, by a video description module, description text corresponding to the synthetic video; and constructing a synthetic data sample in the synthetic dataset based on the synthetic video and the description text.

In a second aspect of the present disclosure, an apparatus for video generation is provided. The apparatus includes: a receiving module configured to receive a video generation request; and a generation module configured to process the video generation request by a video generation model to generate video content, where the video generation model is trained based on a synthetic dataset, and the synthetic dataset is generated based on a process including: generating, by a scene generation module, a synthetic video associated with a virtual three-dimensional object; generating, by a video description module, description text corresponding to the synthetic video; and constructing a synthetic data sample in the synthetic dataset based on the synthetic video and the description text.

In a third aspect of the present disclosure, an electronic device is provided. The device includes at least one processor; and at least one memory, the at least one memory is coupled to the at least one processor and stores instructions executable by the at least one processor. The instructions, when executed by the at least one processor, cause the device to perform the method of the first aspect.

In a fourth aspect of the present disclosure, a computer-readable storage medium is provided. The computer-readable storage medium stores a computer program executable by a processor to perform the method of the first aspect.

It should be appreciated that the content described in the Summary section of the present disclosure is neither intended to limit key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages, and aspects of the embodiments of the present disclosure will become more apparent in combination with the drawings and with reference to the following detailed description. In the drawings, the same or similar reference symbols refer to the same or similar elements, where:

FIG. 1 illustrates a schematic diagram of an example environment in which the embodiments according to the present disclosure may be implemented;

FIG. 2 illustrates an example process of training a video generation model according to some embodiments of the present disclosure;

FIG. 3 illustrates a flowchart of an example process of generating video according to some embodiments of the present disclosure;

FIG. 4 illustrates a schematic structural block diagram of an example apparatus for generating video according to some embodiments of the present disclosure; and

FIG. 5 illustrates a block diagram of an electronic device capable of implementing multiple embodiments of the present disclosure.

### DETAILED DESCRIPTION

Embodiments of the present disclosure are described in more detail hereinafter with reference to the drawings. Although certain embodiments of the present disclosure are shown in the drawings, it should be appreciated that the present disclosure may be implemented in various manners and should not be construed as limited to the embodiments set forth herein. On the contrary, these embodiments are provided for a more thorough and complete understanding of the present disclosure. It should be appreciated that the drawings and embodiments of the present disclosure are only for illustrative purposes, rather than limiting the protection scope of the present disclosure.

It should be noted that the titles of any sections/subsections provided herein are not restrictive. Various embodiments are described throughout this disclosure, and any type of embodiments may be included under any section/subsection. In addition, the embodiments described in any section/subsection may be combined with any other embodiments described in the same section/subsection and/or different section/subsection in any manner.

In the description of the embodiments of the present disclosure, the term “include/comprise” and similar terms should be construed as open-ended inclusions, that is, “include/comprise but not limited to”. The term “based on” should be construed as “at least partially based on”. The term “one embodiment” or “the embodiment” should be construed as “at least one embodiment”. The term “some embodiments” should be construed as “at least some embodiments”. Other definitions, either explicit or implicit, may be included below. The terms “first”, “second” and the like may refer to different or same objects. Other definitions, either explicit or implicit, may be included below.

The embodiments of the present disclosure may involve user data, data acquisition, and/or data use. All these aspects comply with corresponding laws, regulations, and related provisions. In the embodiments of the present disclosure, all data collection, acquisition, processing, machining, forwarding, use, etc., are carried out on the premise that the user is aware and confirms. Accordingly, when implementing the embodiments of the present disclosure, the user should be informed of the type, the range of use, the use scenarios, etc., of the data or information that may be involved, and the authorization of the user should be obtained, in accordance with relevant laws and regulations and in an appropriate manner. The specific manner of informing and/or authorizing may be changed according to the actual situation and application scenarios, and the scope of the present disclosure is not limited in this regard.

The solutions in this specification and embodiments, if involving personal information processing, will be processed on the premise that there is a legal basis (for example, the consent of the personal information subject is obtained, or it is necessary to perform a contract, etc.), and will only be processed within the scope of provisions or agreements. If the user refuses to process personal information other than the necessary information required for the basic functions, it will not affect the user's use of the basic functions.

As mentioned above, the video content generated by a traditional generative model may have defects in physical authenticity. For example, when a camera moves or an object deforms, the generated video often cannot maintain the three-dimensional consistency of the object. In addition, the movement of a person or an object in the generated video may lack realism. For example, when performing a complex action, the body movement of the person may appear stiff or unnatural. When generating a video containing a large range of camera rotation or movement, an existing model may not be able to accurately simulate the movement effect of a real camera, resulting in the generated video looking unnatural.

Embodiments of the present disclosure provide a solution to video generation. The solution includes: receiving a video generation request; and processing the video generation request by a video generation model to generate video content, where the video generation model is trained based on a synthetic dataset, and the synthetic dataset is generated based on a process including: generating, by a scene generation module, a synthetic video associated with a virtual three-dimensional object; generating, by a video description module, description text corresponding to the synthetic video; and constructing a synthetic data sample in the synthetic dataset based on the synthetic video and the description text.

On the one hand, the physical fidelity and realism of the generated video may be significantly improved by training the video generation model using the synthetic dataset. The synthetic video strictly follows physical laws in the generation process, making the generated video closer to a real video in physical characteristics. In addition, the diversity and expandability of the synthetic dataset enable the model to be exposed to a wider range of scenarios and object types, thereby enhancing the generalization ability of the model to different scenarios and objects, and enabling the model to exhibit higher robustness when dealing with various complex scenarios.

Various example implementations of the solution are described in detail hereinafter in further combination with the drawings.

### Example Environment

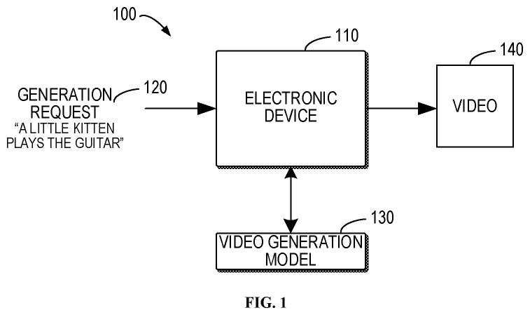

FIG. 1 illustrates a schematic diagram of an example environment 100 in which the embodiments of the present disclosure may be implemented. As shown in FIG. 1, the example environment 100 may include an electronic device 110.

As shown in FIG. 1, the electronic device 110 may receive a video generation request 120 from a user. In some embodiments, the video generation request 120 may include a prompt entered by the user. As an example, the prompt may describe the video content to be generated, for example, “a little kitten plays the guitar”.

In addition, the video generation request 120 may further indicate other appropriate generation parameters. As an example, such generation parameters may include, but are not limited to, the length of the video content, the resolution of the video content, the first frame or the last frame of the video content, etc.

Further, the electronic device 110 may process the video generation request 120 by a video generation model 130 to generate video content 140. As an example, the video generation model 130 may be any appropriate type of generative model, for example, a diffusion model.

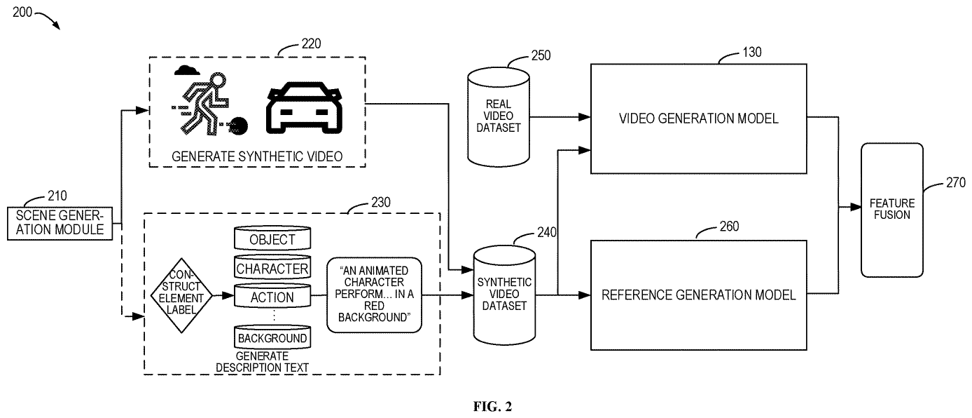

The specific training process of the video generation model 130 will be described in detail below with reference to FIG. 2.

In some embodiments, the electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a television receiver, a radio broadcast receiver, an e-book device, a game device, or any combination thereof, including the accessories and peripherals of these devices, or any combination thereof. In some embodiments, the electronic device 110 may also support any type of user-specific interface (such as a “wearable” circuit, etc.).

In some embodiments, the electronic device 110 may also be an independent physical server, a server cluster or a distributed system composed of multiple physical servers, or may also be a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The electronic device 110 may include, for example, a computing system/server, such as a mainframe computer, an edge computing node, a computing device in a cloud environment, and the like.

It should be appreciated that the structure and function of each element in the environment 100 are described for illustrative purposes only, without suggesting any limitation to the scope of the present disclosure.

Some example embodiments of the present disclosure will be described below with continued reference to the drawings.

### Model Training Process

The process of generating video according to the embodiments of the present disclosure is described below with reference to the drawings. FIG. 2 illustrates a schematic diagram 200 of training a video generation model according to some embodiments of the present disclosure.

As shown in FIG. 2, a synthetic dataset 240 for training the video generation model 130 may be first constructed. Specifically, a scene generation module 210 may be used to generate a synthetic video 220 associated with a virtual three-dimensional object.

In some embodiments, the scene generation module 210 may include a three-dimensional scene generator, which may be used to generate a video scene containing a single three-dimensional object. Specifically, the three-dimensional scene generator may include a plurality of preset three-dimensional assets, which may include a variety of three-dimensional models.

Further, camera parameters associated with a virtual camera may be set. The camera parameters may be used to control the behavior of the virtual camera, including the motion type, the initial position and focus, and the focal length of the virtual camera. Specifically, the motion type of the virtual camera determines the trajectory of the camera around the object, such as basic motion types such as translation, panning, lifting, tilting, translation and rotation, etc. The initial position and focus parameters of the virtual camera are used to specify the starting position of the camera and how to focus on the main object. In addition, the focal length parameter is used to adjust the field of view of the camera, control the size ratio of the object on the screen, thereby simulating different shooting angles and effects.

In addition, in order to further enhance the realism of the scene, the scene generation module 210 may further perform joint modeling of light and the environment. As an example, the scene generation module 210 may support three main configurations: environment mapping, solid color indoor room, and empty scene.

In some examples, the environment map not only provides the background, but also acts as the main light source. The solid color indoor room configuration uses two light sources for illumination, one above the object and the other placed elsewhere in the scene to mimic the lighting effects of an indoor environment. The empty scene configuration is illuminated by an environment map or two light sources, with a blank surrounding environment, and this configuration is suitable for scenes that require a cleaner background.

In some embodiments, in order to generate a large number of diverse synthetic videos, the above parameters may be defined by configuration information (for example, a configuration file). The scene generation module 210 may set a corresponding virtual scene by parsing the configuration information, and may use a rendering engine to render the scene into a video.

In some embodiments, in addition to the object parameters (for example, the type, the size, etc.) of the virtual three-dimensional object and the camera parameters (for example, the position of the camera, the motion trajectory of the camera, etc.) of the virtual camera mentioned above, the configuration information may further define scene parameters of a virtual scene associated with the virtual three-dimensional object. As an example, the scene parameters may indicate light and environment parameters for constructing the virtual scene in which the virtual three-dimensional object is placed. For example, the scene parameters may indicate whether the virtual three-dimensional object is placed in an outdoor environment or an indoor environment.

In some embodiments, the specific value of a parameter may also be determined by sampling from a preset value range of the parameter. As an example, random sampling may be performed based on the probability distribution of the parameter to determine the specific value of the parameter. Therefore, in the large-scale generation process, each sampling will generate a unique configuration file, which in turn will be rendered into an independent synthetic video. In this way, the embodiments of the present disclosure may generate a large number of diverse synthetic videos with minimal human intervention.

Further, a description text (caption) of the synthetic video 220 may also be generated by a video description module 230. In some embodiments, unlike generating a text description of a video directly by a visual model, the video description module 230 may construct the final description text by combining a plurality of pieces of element description content of the synthetic video 220 about a plurality of preset elements.

Specifically, the synthetic video is generated by combining one or more three-dimensional objects, scene settings, and camera movements. Therefore, when generating the description text, the video description module 230 first generates a detailed descriptive text for each independent element (such as a three-dimensional object, a virtual scene, a movement of a virtual camera, etc.) separately. For example, for a video containing a dancer, the video description module 230 may separately describe the action of the dancer (such as “performing hip-hop dance movements”), the scene background (such as “in an indoor environment”), and the camera movement pattern (such as “the camera is rotating around the dancer”).

In some embodiments, the video description module 230 may generate the element description content about each independent element based on the synthetic video 220 by a visual model. In some embodiments, the visual model may further generate the corresponding element description content based on the synthesis parameters used to generate the synthetic video 220, for example.

As an example, when describing the camera movement, the visual model may generate the corresponding description text based on the video content 220 and the camera movement parameters used by the scene generation module 210.

In addition, this description text generation method greatly reduces the required time cost. Assuming that the synthetic video 220 has N different three-dimensional objects, M scene settings, and C camera movement patterns, the traditional video description method needs to generate description texts for N×M×C different video combinations, respectively. However, by means of separately generating the description texts of the elements, only N+M+C pieces of element description content need to be generated, and then the description text of any video may be generated by combining these texts. This not only significantly reduces the complexity of generating the description text, but also improves the speed and efficiency of generating the description text.

Further, a synthetic data sample in the synthetic video dataset 240 may be constructed based on the generated synthetic video 220 and the corresponding description text. How to train the video generation model 130 by the synthetic video dataset 240 is further introduced below.

As shown in FIG. 2, the video generation model 130 may be trained by mixing the real video dataset 250 and the synthetic video dataset 240. The real video dataset 250 may include real video content that has been shot.

In addition, in order to balance the distribution difference between the real video and the synthetic video, a reference generation model 260 may also be used to assist in training the video generation model 130. Specifically, the reference generation model 260 may have, for example, the same model structure as the video generation model 130, for example, both may be diffusion models.

Further, the reference generation model 260 may be trained, for example, only based on the synthetic video dataset 240. Specifically, the synthetic video dataset 240 may be used to construct a training sample, which may include the synthetic video 220 and the corresponding description text. Unlike the description text for training the video generation model 130, the description text for training the reference generation model 260 may ignore the description content of the synthetic video 220 about a target element, and such description content may be retained in the description text for training the video generation model 130.

For example, since the realism of the action of the synthetic video 220 about the virtual three-dimensional object is relatively weak, the description text for training the reference generation model 260 may not include the description content about the action of the object. This may enable the reference generation model to focus more on the visual style of the synthetic video.

Further, in the process of training the video generation model 130, the same input prompt may be provided to the video generation model 130 and the reference generation model 260. Taking the video generation model 130 and the reference generation model 260 as diffusion models as an example, feature fusion may be performed on the features in the noise reduction process of the two models at block 270.

Specifically, the feature fusion process may be expressed as:

$${l}_{k} = {V}_{θ} ( {l}_{k - 1} , t ) - α f ( {V}_{σ} , {l}_{k - 1} , \hat{t} , \hat{n} ) + β f ( {V}_{θ} , {l}_{k - 1} , t , n )$$

where V_{θ} represents the video generation model 130, V_{σ} represents the reference generation model 260, lₖ₋₁ represents the first feature at the (k−1)-th noise reduction time step (that is, the first time step), t represents the positive prompt of the video generation model 130, \hat{t} represents the positive prompt of the reference generation model 260, n represents the negative prompt of the video generation model 130, \hat{n} represents the negative prompt of the reference generation model 260, and α and β are weight coefficients. f(V_{σ},lₖ₋₁, \hat{t},\hat{n}) represents the first guidance information corresponding to the k-th noise reduction time step (that is, the second noise reduction time step) determined by the reference generation model based on the input prompt and the first feature corresponding to the (k−1)-th noise reduction time step; f(V_{θ},lₖ₋₁,t,n) represents the second guidance information corresponding to the k-th noise reduction time step determined by the video generation model based on the input prompt and the first feature corresponding to the (k−1)-th noise reduction time step. As an example, the second guidance information may be expressed as f_{θ}(V_{θ},l,t,n)=V_{θ}(l,t)−V_{θ}(l,n), that is, the second guidance information may represent the difference between the noise reduction results corresponding to the positive prompt and the negative prompt.

Therefore, according to the above formula, the second feature lₖ corresponding to the second noise reduction time step may be determined based on the noise reduction result of the video generation model at the second noise reduction time step, the first guidance information, and the second guidance information.

Further, the generation result of the video generation model 130 may be determined based on the second feature, and the video generation model 130 may be trained based on the generation result and the synthetic video. For example, after completing a plurality of rounds of noise reduction processes, the video feature may be determined, the generation result may be obtained based on the video feature, and the video generation model 130 may be trained based on the difference between the generation result and the synthetic video.

In addition, in order to evaluate the performance of the model in the training process, quantitative and qualitative evaluation indicators may also be used for the model. In terms of quantitative evaluation, the physical fidelity of the generated video may be measured by indicators such as three-dimensional reconstruction error and human posture estimation confidence. These indicators may effectively evaluate the performance of the generated video in terms of three-dimensional consistency, human posture integrity, etc. In terms of qualitative evaluation, a professional may subjectively evaluate the physical fidelity of the generated video to ensure that the generation result of the model conforms to human visual perception.

Through the above training process, on the one hand, the physical fidelity and realism of the generated video may be significantly improved by training the video generation model using the synthetic dataset. The synthetic video strictly follows physical laws in the generation process, making the generated video closer to a real video in physical characteristics. In addition, the diversity and expandability of the synthetic dataset enable the model to be exposed to a wider range of scenarios and object types, thereby enhancing the generalization ability of the model to different scenarios and objects, and enabling the model to exhibit higher robustness when dealing with various complex scenarios.

### Example Process

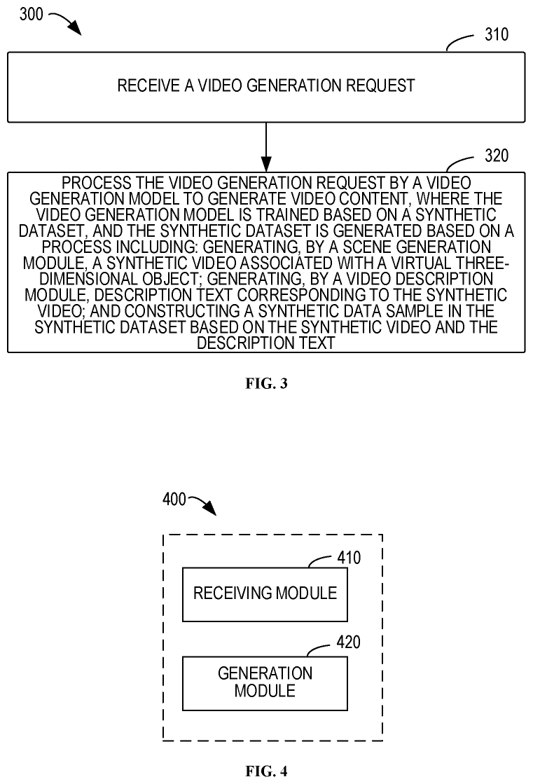

FIG. 3 illustrates a flowchart of an example process 300 of generating video according to some embodiments of the present disclosure. The process 300 may be implemented at the electronic device 110.

As shown in the figure, at block 310, the electronic device 110 receives a video generation request.

At block 320, the electronic device 110 processes the video generation request by a video generation model to generate video content. The video generation model is trained based on a synthetic dataset, and the synthetic dataset is generated based on a process including: generating, by a scene generation module, a synthetic video associated with a virtual three-dimensional object; generating, by a video description module, description text corresponding to the synthetic video; and constructing a synthetic data sample in the synthetic dataset based on the synthetic video and the description text.

In some embodiments, generating, by the scene generation module, the synthetic video associated with the virtual three-dimensional object includes: obtaining configuration information describing a set of parameters for generating the synthetic video; and processing, by the scene generation module, the configuration information to generate the synthetic video.

In this way, the embodiments of the present disclosure may precisely control the generation process of the synthetic video through the configuration information, thereby improving the controllability of the synthetic video.

In some embodiments, a value of at least one parameter in the set of parameters is determined by sampling from a preset value range.

In this way, the embodiments of the present disclosure may improve the randomness and diversity of the synthetic video.

In some embodiments, the set of parameters includes at least one of: an object parameter of the virtual three-dimensional object; a camera parameter of a virtual camera associated with the synthetic video; and a scene parameter of a virtual scene associated with the virtual three-dimensional object.

In this way, the embodiments of the present disclosure may ensure that the synthetic video conforms to physical laws and realism.

In some embodiments, generating, by the video description module, the description text corresponding to the synthetic video includes: generating, by the video description module, a plurality of pieces of element description content with respect to a plurality of preset elements of the synthetic video; and constructing the description text corresponding to the synthetic video based on the plurality of pieces of element description content.

In this way, the embodiments of the present disclosure may improve the accuracy of the description text, and may enhance the understanding ability of the model to the video content.

In some embodiments, at least one piece of element description content in the plurality of pieces of element description content is determined based on a synthesis parameter of the synthetic video.

In this way, the embodiments of the present disclosure may describe the synthetic video more accurately, thereby improving the training effect of the model.

In some embodiments, the plurality of preset elements include at least one of: the virtual three-dimensional object; a virtual scene associated with the virtual three-dimensional object; and a virtual camera associated with the synthetic video.

In this way, the embodiments of the present disclosure may cover the key elements of video generation, thereby providing more comprehensive semantic information.

In some embodiments, the video generation model is trained based on a training dataset, the training dataset includes the synthetic dataset and a real dataset, and the real dataset includes filmed video content.

In this way, the embodiments of the present disclosure may perform training by combining the synthetic data and the real data, so that the model may learn both the physical fidelity of the synthetic data and the visual style of the real data, thereby generating a video that conforms to physical laws and has realism.

In some embodiments, the video generation model is a diffusion model, and the video generation model is trained based on a process including: determining, by a reference generation model, first guidance information corresponding to a second noise reduction time step based on input prompt and a first feature corresponding to a first noise reduction time step, the input prompt being determined based on the description text; determining, by the video generation model, second guidance information corresponding to the second noise reduction time step based on the input prompt and the first feature; determining a second feature corresponding to the second noise reduction time step based on a noise reduction result of the video generation model at the second noise reduction time step, the first guidance information, and the second guidance information; determining a generation result of the video generation model based on the second feature; and training the video generation model based on the generation result and the synthetic video.

In this way, the embodiments of the present disclosure may use the reference generation model to capture the visual patterns in the synthetic data and suppress these patterns in the training process, which may effectively reduce the visual artifacts introduced by the synthetic data and improve the realism of the generated video.

In some embodiments, the input prompt includes positive prompt and negative prompt determined based on the description text.

In this way, the embodiments of the present disclosure may more precisely know that the model generates the video content that meets the requirements.

In some embodiments, the description text is first description text, and the reference generation model is trained based on a process including: constructing, by the synthetic dataset, a training sample including the synthetic video and a second description text, the second description text excluding description content with respect to a target element of the synthetic video, and the first description text including the description content about the target element of the synthetic video; and training, by the training sample, the reference generation model.

In this way, the embodiments of the present disclosure may enable the reference video model to focus on capturing the visual patterns in the synthetic data, thereby avoiding the generation of visual artifacts.

In some embodiments, the target element includes an action of the virtual three-dimensional object.

In this way, the embodiments of the present disclosure may improve the realism of the generated video content.

### Example Apparatus and Device

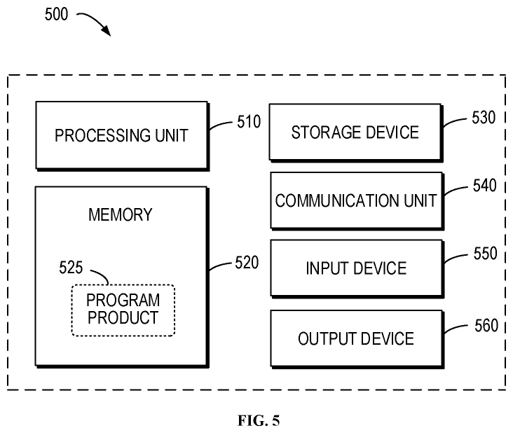

The embodiments of the present disclosure further provide corresponding apparatuses for implementing the above methods or processes. FIG. 4 illustrates a schematic structural block diagram of an example apparatus 400 for generating video according to some embodiments of the present disclosure. The apparatus 400 may be implemented as or included in the electronic device 110. Each module/component in the apparatus 400 may be implemented by hardware, software, firmware, or any combination thereof.

As shown in FIG. 4, the apparatus 400 includes a receiving module 410 configured to receive a video generation request; and a generation module 420 configured to process the video generation request by a video generation model to generate video content. The video generation model is trained based on a synthetic dataset, and the synthetic dataset is generated based on a process including: generating, by a scene generation module, a synthetic video associated with a virtual three-dimensional object; generating, by a video description module, a description text corresponding to the synthetic video; and constructing a synthetic data sample in the synthetic dataset based on the synthetic video and the description text.

In some embodiments, generating, by the scene generation module, the synthetic video associated with the virtual three-dimensional object includes: obtaining configuration information describing a set of parameters for generating the synthetic video; and processing, by the scene generation module, the configuration information to generate the synthetic video.

In some embodiments, a value of at least one parameter in the set of parameters is determined by sampling from a preset value range.

In some embodiments, the set of parameters includes at least one of: a object parameter of the virtual three-dimensional object; a camera parameter of a virtual camera associated with the synthetic video; and a scene parameter of a virtual scene associated with the virtual three-dimensional object.

In some embodiments, generating, by the video description module, the description text corresponding to the synthetic video includes: generating, by the video description module, a plurality of pieces of element description content with respect to a plurality of preset elements of the synthetic video; and constructing the description text corresponding to the synthetic video based on the plurality of pieces of element description content.

In some embodiments, at least one piece of element description content in the plurality of pieces of element description content is determined based on synthesis parameters of the synthetic video.

In some embodiments, the plurality of preset elements include at least one of: the virtual three-dimensional object; a virtual scene associated with the virtual three-dimensional object; and a virtual camera associated with the synthetic video.

In some embodiments, the video generation model is trained based on a training dataset, the training dataset includes the synthetic dataset and a real dataset, and the real dataset includes filmed video content.

In some embodiments, the video generation model is a diffusion model, and the video generation model is trained based on a process including: determining, by a reference generation model, first guidance information corresponding to a second noise reduction time step based on input prompt and a first feature corresponding to a first noise reduction time step, the input prompt being determined based on the description text; determining, by the video generation model, second guidance information corresponding to the second noise reduction time step based on the input prompt and the first feature; determining a second feature corresponding to the second noise reduction time step based on a noise reduction result of the video generation model at the second noise reduction time step, the first guidance information, and the second guidance information; determining a generation result of the video generation model based on the second feature; and training the video generation model based on the generation result and the synthetic video.

In some embodiments, the input prompt includes positive prompt and negative prompt determined based on the description text.

In some embodiments, the description text is a first description text, and the reference generation model is trained based on a process including: constructing, by the synthetic dataset, a training sample including the synthetic video and a second description text, the second description text excluding description content with respect to a target element of the synthetic video, and the first description text including the description content with respect to the target element of the synthetic video; and training, by the training sample, the reference generation model.

In some embodiments, the target element includes an action of the virtual three-dimensional object.

FIG. 5 illustrates a block diagram of an electronic device 500 in which one or more embodiments of the present disclosure may be implemented. It should be appreciated that the electronic device 500 shown in FIG. 5 is merely illustrative, without suggesting any limitation to the functions and scopes of the embodiments described herein. The electronic device 500 shown in FIG. 5 may be used to implement the electronic device 110 in FIG. 1.

As shown in FIG. 5, the electronic device 500 is in the form of a general-purpose electronic device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and may execute various processes based on the programs stored in the memory 520. In a multi-processor system, a plurality of processing units execute computer executable instructions in parallel to improve the parallel processing capability of the electronic device 500.

The electronic device 500 typically includes a plurality of computer storage medium. Such medium may be any available medium that is accessible to the electronic device 500, including, but not limited to, volatile and non-volatile medium, removable and non-removable medium. The memory 520 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 530 may be any removable or non-removable medium, and may include a machine-readable medium such as a flash drive, a disk, or any other medium, which may be used to store information and/or data and may be accessed within the electronic device 500.

The electronic device 500 may further include additional removable/non-removable, volatile/non-volatile memory medium. Although not shown in FIG. 5, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 520 may include a computer program product 525, which has one or more program modules configured to perform various methods or acts of the various embodiments of the present disclosure.

The communication unit 540 enables communication with other electronic devices through the communication medium. Additionally, the functions of the components of the electronic device 500 may be implemented by a single computing cluster or a plurality of computing machines, which may communicate through communication connections. Therefore, the electronic device 500 may use a logical connection with one or more other servers, a network personal computer (PC), or another network node to operate in a networked environment.

The input device 550 may be one or more input devices, such as a mouse, a keyboard, a tracking ball, etc. The output device 560 may be one or more output devices, such as a display, a speaker, a printer, etc. The electronic device 500 may further communicate with one or more external devices (not shown) through the communication unit 540 as needed, the external devices such as a storage device, a display device, etc., communicate with one or more devices that enable the user to interact with the electronic device 500, or communicate with any devices (for example, a network card, a modem, etc.) that enable the electronic device 500 to communicate with one or more other electronic devices. Such communication may be performed via input/output (I/O) interfaces (not shown).

According to an illustrative implementation of the present disclosure, there is provided a computer-readable storage medium having computer executable instructions stored thereon, where the computer executable instructions are executed by a processor to perform the method described above. According to an illustrative implementation of the present disclosure, there is further provided a computer program product tangibly stored on a non-transitory computer-readable medium and including computer executable instructions, and the computer executable instructions are executed by a processor to perform the method described above.

Various aspects of the present disclosure are described herein with reference to flowcharts and/or block diagrams of methods, apparatuses, devices, and computer program products implemented according to the present disclosure. It should be appreciated that each block of the flowcharts and/or block diagrams, and combinations of blocks in the flowcharts and/or block diagrams, may be implemented by computer readable program instructions.

These computer readable program instructions may be provided to the processing unit of a general-purpose computer, a special-purpose computer, or other programmable data processing apparatus to produce a machine, so that when these instructions are executed by the processing unit of the computer or other programmable data processing apparatus, an apparatus for implementing the functions/actions specified in one or more blocks of the flowcharts and/or block diagrams is produced. These computer readable program instructions may also be stored in a computer-readable storage medium, these instructions enable the computer, the programmable data processing apparatus, and/or other devices to work in a particular manner, and thus, the computer-readable medium storing the instructions includes an article of manufacture, which includes instructions for implementing various aspects of the functions/actions specified in one or more blocks of the flowcharts and/or block diagrams.

The computer readable program instructions may be loaded onto a computer, other programmable data processing apparatus, or other device, so that a series of operation steps are performed on the computer, other programmable data processing apparatus, or other device to produce a computer-implemented process, so that the instructions executed on the computer, other programmable data processing apparatus, or other device implement the functions/actions specified in one or more blocks of the flowcharts and/or block diagrams.

The flowcharts and block diagrams in the drawings illustrate the possibly implemented architectures, functions, and operations of the systems, methods and computer program products according to various implementations of the present disclosure. In this regard, each block in the flowchart or block diagrams may represent a module, a program segment, or a portion of instructions, which includes one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and combinations of the blocks in the block diagrams and/or flowcharts may be implemented by a special-purpose hardware-based system that performs the specified functions or actions, or may be implemented by a combination of special-purpose hardware and computer instructions.

The implementations of the present disclosure have been described above, and the above description is illustrative, non-exhaustive, and not limited to the disclosed implementations. Many modifications and variations will be apparent to those of ordinary skill in the art without departing from the scope of the illustrated implementations. The terminology used herein is chosen to best explain the principles of the implementations, the practical applications, or improvements to the technology in the market, or to enable other those of ordinary skill in the art to understand the various implementations disclosed herein.

1. A method for video generation, comprising:
receiving a video generation request; and
processing the video generation request by a video generation model to generate video content, wherein the video generation model is trained based on a synthetic dataset, and the synthetic dataset is generated based on a process comprising:
generating, by a scene generation module, a synthetic video associated with a virtual three-dimensional object;
generating, by a video description module, description text corresponding to the synthetic video; and
constructing a synthetic data sample in the synthetic dataset based on the synthetic video and the description text.

2. The method of claim 1, wherein generating, by the scene generation module, the synthetic video associated with the virtual three-dimensional object comprises:
obtaining configuration information describing a set of parameters for generating the synthetic video; and
processing, by the scene generation module, the configuration information to generate the synthetic video.

3. The method of claim 2, wherein a value of at least one parameter in the set of parameters is determined by sampling from a preset value range.

4. The method of claim 2, wherein the set of parameters comprises at least one of:
an object parameter of the virtual three-dimensional object;
a camera parameter of a virtual camera associated with the synthetic video; and
a scene parameter of a virtual scene associated with the virtual three-dimensional object.

5. The method of claim 1, wherein generating, by the video description module, the description text corresponding to the synthetic video comprises:
generating, by the video description module, a plurality of pieces of element description content with respect to a plurality of preset elements of the synthetic video; and
constructing the description text corresponding to the synthetic video based on the plurality of pieces of element description content.

6. The method of claim 5, wherein at least one piece of element description content in the plurality of pieces of element description content is determined based on a synthesis parameter of the synthetic video.

7. The method of claim 5, wherein the plurality of preset elements comprise at least one of:
the virtual three-dimensional object;
a virtual scene associated with the virtual three-dimensional object; and
a virtual camera associated with the synthetic video.

8. The method of claim 1, wherein the video generation model is trained based on a training dataset, the training dataset comprises the synthetic dataset and a real dataset, and the real dataset comprises filmed video content.

9. The method of claim 1, wherein the video generation model is a diffusion model, and the video generation model is trained based on a process comprising:
determining, by a reference generation model, first guidance information corresponding to a second noise reduction time step based on input prompt information and a first feature corresponding to a first noise reduction time step, the input prompt information being determined based on the description text;
determining, by the video generation model, second guidance information corresponding to the second noise reduction time step based on the input prompt information and the first feature;
determining a second feature corresponding to the second noise reduction time step based on a noise reduction result of the video generation model at the second noise reduction time step, the first guidance information, and the second guidance information;
determining a generation result of the video generation model based on the second feature; and
training the video generation model based on the generation result and the synthetic video.

10. The method of claim 9, wherein the input prompt information comprises positive prompt information and negative prompt information determined based on the description text.

11. The method of claim 9, wherein the description text is first description text, and the reference generation model is trained based on a process comprising:
constructing, by the synthetic dataset, a training sample comprising the synthetic video and second description text, the second description text excluding description content with respect to a target element of the synthetic video, and the first description text comprising the description content with respect to the target element of the synthetic video; and
training, by the training sample, the reference generation model.

12. The method of claim 11, wherein the target element comprises an action of the virtual three-dimensional object.

13. An electronic device, comprising:
at least one processing unit; and
at least one memory coupled to the at least one processing unit and storing instructions executable by the at least one processing unit, the instructions, when executed by the at least one processing unit, causing the electronic device to perform operations comprising:
receiving a video generation request; and
processing the video generation request by a video generation model to generate video content, wherein the video generation model is trained based on a synthetic dataset, and the synthetic dataset is generated based on a process comprising:
generating, by a scene generation module, a synthetic video associated with a virtual three-dimensional object;
generating, by a video description module, description text corresponding to the synthetic video; and
constructing a synthetic data sample in the synthetic dataset based on the synthetic video and the description text.

14. The electronic device of claim 13, wherein generating, by the scene generation module, the synthetic video associated with the virtual three-dimensional object comprises:
obtaining configuration information describing a set of parameters for generating the synthetic video; and
processing, by the scene generation module, the configuration information to generate the synthetic video.

15. The electronic device of claim 14, wherein a value of at least one parameter in the set of parameters is determined by sampling from a preset value range.

16. The electronic device of claim 14, wherein the set of parameters comprises at least one of:
an object parameter of the virtual three-dimensional object;
a camera parameter of a virtual camera associated with the synthetic video; and
a scene parameter of a virtual scene associated with the virtual three-dimensional object.

17. The electronic device of claim 13, wherein generating, by the video description module, the description text corresponding to the synthetic video comprises:
generating, by the video description module, a plurality of pieces of element description content with respect to a plurality of preset elements of the synthetic video; and
constructing the description text corresponding to the synthetic video based on the plurality of pieces of element description content.

18. The electronic device of claim 17, wherein at least one piece of element description content in the plurality of pieces of element description content is determined based on a synthesis parameter of the synthetic video.

19. The electronic device of claim 17, wherein the plurality of preset elements comprise at least one of:
the virtual three-dimensional object;
a virtual scene associated with the virtual three-dimensional object; and
a virtual camera associated with the synthetic video.

20. A non-transitory computer-readable storage medium having a computer program stored thereon, the computer program being executable by a processor to perform operations comprising:
receiving a video generation request; and
processing the video generation request by a video generation model to generate video content, wherein the video generation model is trained based on a synthetic dataset, and the synthetic dataset is generated based on a process comprising:
generating, by a scene generation module, a synthetic video associated with a virtual three-dimensional object;
generating, by a video description module, description text corresponding to the synthetic video; and
constructing a synthetic data sample in the synthetic dataset based on the synthetic video and the description text.
